(19) United States
(12) Patent Application Publication
(10) Pub. No.: US 2022/0289184 A1
(43) Pub. Date: Sep. 15, 2022

(54) Method and Device for Scheduling a Trajectory of a Vehicle

(71) Applicant: Aptiv Technologies Limited, St. Michael (BB)

(72) Inventor: Viktor Svensson, Göteborg (SE)

(21) Appl. No.: 17/653,826

(22) Filed: Mar. 7, 2022

(30) Foreign Application Priority Data
Mar. 12, 2021 (EP) 21162318.6

(51) Int. Cl. B60W 30/12; B60W 40/109; B60W 40/072; B60W 30/14

(52) U.S. Cl. CPC B60W 30/12; B60W 40/109; B60W 40/072; B60W 30/14; B60W 2520/14; B60W 2520/125

(57) ABSTRACT

Methods and systems for scheduling a trajectory of a vehicle are provided. Kinematic parameters of the vehicle are detected by using at least one vehicle state sensor, and environmental parameters of the vehicle are detected by using at least one environment sensor. A curvature rate and a longitudinal jerk are estimated based on respective cost functions depending from the kinematic parameters and the environmental parameters of the vehicle. A scheduled trajectory of the vehicle is estimated based on the curvature rate and the longitudinal jerk.

### CROSS-REFERENCE OF RELATED APPLICATION

This application claims priority to European Patent Application Number 21162318.6, filed Mar. 12, 2021, the disclosure of which is hereby incorporated by reference in its entirety herein.

### BACKGROUND

Advanced driver assistance systems (ADAS) support drivers in order to drive a vehicle more safely and comfortably. These systems are provided e.g. for keeping the vehicle within lane boundaries and to avoid getting too close to other objects by steering and/or braking/accelerating. Such safety functionalities are usually realized separately by individual functions of an advanced driver assistance system which are optimized for a specific purpose.

An adaptive cruise control, for example, attempts to maintain a speed set by a driver of the vehicle or to keep a certain distance to a target vehicle in front of a host vehicle in which the adaptive cruise control is installed. Therefore, the adaptive cruise control is effective only to control the speed of the vehicle in a longitudinal direction, and the driver has to control a steering wheel of the vehicle, i.e. any lateral movement.

On the other hand, a lane centering and/or lane keeping assistance is provided for lateral control and keeps a vehicle in a lane by steering the wheels in order to compensate any undesired lateral deviations with respect e.g. to a distance from lane markers. However, if a lane keeping assistance is activated, there is no speed control for the vehicle. Also, the steering is controlled by the lane keeping assistance, a driver has still to control a steering wheel and to take over control if necessary.

Furthermore, there are methods and devices for planning or scheduling a trajectory of a vehicle which are known in the related art. The scheduled trajectory of the vehicle may be used as an input for further assistance systems, e.g. in order to coordinate the adaptive cruise control for the longitudinal direction and the lane centering and/or lane keeping assistance for the lateral movement. However, these methods and devices for trajectory planning may be computationally expensive, e.g. if they are implemented based on a model predictive control.

Accordingly, there is a need to have a method and a device for scheduling a trajectory of a vehicle requiring a low computational effort while providing a flexible configuration.

### SUMMARY

The present disclosure provides a computer implemented method, a computer system and a non-transitory computer readable medium according to the independent claims. Embodiments are given in the subclaims, the description and the drawings.

In one aspect, the present disclosure is directed at a computer implemented method for scheduling a trajectory of a vehicle. According to the method, kinematic parameters of the vehicle are detected by using at least one vehicle state sensor, and environmental parameters of the vehicle are detected by using at least one environment sensor. Via a processing unit, a curvature rate and a longitudinal jerk are estimated based on respective cost functions depending from the kinematic parameters and the environmental parameters of the vehicle. A scheduled trajectory of the vehicle is estimated based on the curvature rate and the longitudinal jerk via the processing unit.

The at least one vehicle state sensor is able to provide the dynamic and static states of the vehicle, e.g. the current position, the longitudinal and lateral velocity and therefore the heading of the vehicle, the longitudinal acceleration and the lateral acceleration of the vehicle etc. Hence, the vehicle state sensors may include a global positioning system (GPS), a speedometer, an accelerometer, for example.

The at least one environment sensor may be able to determine parameters and/or properties of the road or lane on which the vehicle is currently driving and parameters and/or properties of objects in the environment of the vehicle, e.g. other vehicles, pedestrians etc. For scheduling the trajectory of the vehicle, the at least one environment sensor may determine the curvature and the width of the lane, for example. In detail, the at least one environment sensor may include a camera, a radar system and/or a Lidar system.

Estimating the scheduled trajectory relies on the curvature rate for the lateral direction and on the longitudinal jerk for the longitudinal direction which is tangent to the direction in which the vehicle is currently driving. It turned out that the curvature rate and the longitudinal jerk are suitable control values for scheduling a reliable trajectory of the vehicle. Furthermore, estimating the curvature rate and the longitudinal jerk based on respective cost functions requires quite a low computational effort, e.g. in comparison to methods and devices which rely on a model predictive control.

The respective cost functions for estimating the curvature rate and the longitudinal jerk, respectively, may be defined independently from each other and may depend on further cost functions which are related individually to one or more (i.e. a subset) of the kinematic parameters and/or the environmental parameters of the vehicle. All cost functions may be defined and scaled independently from each other based on the individual configuration of the vehicle. Hence, the method allows for a flexible adaptation to the specific configuration of the vehicle.

The method may comprise one or more of the following features:

The respective cost functions may be smoothed after estimating the scheduled trajectory, a revised curvature rate and a revised longitudinal jerk may be estimated based on the smoothed cost functions, and a revised scheduled trajectory may be estimated based on the revised curvature rate and the revised longitudinal jerk. The estimated curvature rate and the estimated longitudinal jerk may each comprise an equilibrium contribution and a stabilizing contribution which may depend on the respective cost functions.

The equilibrium contribution of the estimated curvature rate may depend on a curvature rate cost function which may be balanced with a lateral offset cost function, a heading cost function, and a curvature cost function. The stabilizing contribution of the estimated curvature rate may be defined based on the curvature rate cost function, a temporal change of the lateral offset cost function and of the heading cost function, and a change of the curvature cost function per curvature. Cost related to lateral dynamics of the vehicle may be estimated based on a subset of the kinematic parameters and of the environmental parameters of the vehicle, and the cost related to lateral dynamics may be transformed in order to determine the curvature rate cost function, the lateral offset cost function, the heading cost function, and the curvature cost function.

The equilibrium contribution of the estimated longitudinal jerk may depend on a longitudinal jerk cost function which may be balanced with a range cost function, a range rate cost function and an acceleration cost function. The stabilizing contribution of the estimated longitudinal jerk may be defined based on the longitudinal jerk cost function, a temporal change of the range cost function and of the range rate cost function, and a change of the acceleration cost function per acceleration. Cost related to longitudinal dynamics of the vehicle may be estimated based on a subset of the kinematic parameters and of the environmental parameters of the vehicle. The cost related to longitudinal dynamics may be transformed in order to determine the longitudinal jerk cost function, the range cost function, the range rate cost function, and the acceleration cost function.

The estimated longitudinal jerk may include a longitudinal response to a target object and a longitudinal response to a course of a lane on which the vehicle is currently located, and the longitudinal response to the target object may depend on a range to the target object. The minimum of the longitudinal response to the target object and the longitudinal response to the course of the lane may be selected as the estimated longitudinal jerk.

Estimating the scheduled trajectory of the vehicle may further be based on a reference curvature which may be determined based a course of a lane derived from the environmental parameters.

According to an embodiment, the respective cost functions may be smoothed after estimating the scheduled trajectory. A revised curvature rate and a revised longitudinal jerk may be estimated based on the smoothed cost functions, and a revised scheduled trajectory may be estimated based on the revise curvature rate and the revised longitudinal jerk.

In detail, each value of the respective cost functions may depend on a planning index which corresponds to a time increment with respect to the scheduled trajectory, i.e. “along” the scheduled trajectory starting from the vehicle. The respective cost functions may be smoothed starting from the last planning index up to the first planning index, whereas the revised scheduled trajectory may be estimated thereafter starting from the first planning index up to the last planning index. In other words, for the cost functions a “back propagation” may be performed due to the smoothing starting from the end of the scheduled trajectory. In contrast, the revised scheduled trajectory may be estimated in the “forward” direction in the same manner as the original trajectory.

Due to the smoothing of the cost functions via back propagation, sudden changes in the revised curvature rate and the revised longitudinal jerk may be prevented which might be caused by discontinuities in the acquired input data, i.e. in the kinematic and environmental parameters, e.g. due to a change of a speed limit or when the vehicle changes the lane etc. Hence, the revised scheduled trajectory may be smoothed as well when smoothing the cost functions which may lead to a smooth behavior of the vehicle when driving along the revised scheduled trajectory.

According to a further embodiment, the estimated curvature rate and the estimated longitudinal jerk may each comprise an equilibrium contribution and a stabilizing contribution which may depend on the respective cost functions. The equilibrium contribution of the estimated curvature rate may depend on a curvature rate cost function which may be balanced with a lateral offset cost function, a heading cost function, and a curvature cost function. Similarly, the equilibrium contribution of the estimated longitudinal jerk may depend on a longitudinal jerk cost function which is balanced with a range cost function, a range rate cost function and an acceleration cost function.

It turned out that the respective equilibrium contribution being determined based on a balance of cost functions may ensure an adequate response to an error in the vehicle states determined based on the kinematic parameters of the vehicle. This response may be reflected in the scheduled trajectory. However, it turned out further that the respective equilibrium contribution may be not efficient in order to ensure stability. Hence, the second term or stabilizing contribution may be introduced.

The stabilizing contribution of the estimated curvature rate may be defined based on the curvature rate cost function, a temporal change of the lateral offset cost function and of the heading cost function, and a change of the curvature cost function per curvature. Similarly, the stabilizing contribution of the estimated longitudinal jerk may be defined based on the longitudinal jerk cost function, a temporal change of the range cost function and of the range rate cost function, and a change of the acceleration cost function per acceleration. Hence, changes or derivatives of dynamic parameters defining the respective cost functions may be reflected in the stabilizing contributions.

Furthermore, cost related to the lateral dynamics of the vehicle may be estimated based on a subset of the kinematic parameters and of the environmental parameters of the vehicle, and the cost related to the lateral dynamics may be transformed in order to determine the curvature rate cost function, the lateral offset cost function, the heading cost function and the curvature cost function. Similarly, cost related to the longitudinal dynamics of the vehicle may be estimated based on a further subset of the kinematic parameters and of the environmental parameters of the vehicle, and the cost related to the longitudinal dynamics may be transformed in order to determine the longitudinal jerk cost function, the range cost function, the range rate cost function and the acceleration cost function. Hence, the flexibility when defining the cost function may be enhanced since the respective subset of the kinematic parameters and of the environmental parameters of the vehicle may be individually adapted to the configuration of the vehicle.

The estimated longitudinal jerk may include a longitudinal response to a target object and a longitudinal response to a course of a lane on which the vehicle is currently located. The longitudinal response to the target object may depend on a range to the target object. In contrast, the longitudinal response to the course of the lane may be independent from any range parameters referring to target objects. Furthermore, the minimum of the longitudinal response to the target object and of the longitudinal response to the course of the lane may be selected as the estimated longitudinal jerk. Hence, overestimating one of the responses will be avoided.

According to a further embodiment, estimating the scheduled trajectory of the vehicle may further be based on a reference curvature which may be determined based on a course of a lane derived from the environmental parameters. The reference curvature may be determined between a minimum curvature and a maximum curvature which may be permissible for the vehicle without leaving the lane. Incorporating the reference curvature when estimating the scheduled trajectory of the vehicle may improve the reliability of the final scheduled trajectory on which the further assistance systems of the vehicle may rely.

In another aspect, the present disclosure is directed at a device for scheduling a trajectory of a vehicle. The device comprises at least one vehicle state sensor configured to detect kinematic parameters of the vehicle, at least one environment sensor configured to detect environmental parameters of the vehicle, and a processing unit. The processing unit is configured to estimate a curvature rate and a longitudinal jerk based on respective cost functions depending from the kinematic parameters and the environmental parameters of the vehicle, and to estimate a scheduled trajectory of the vehicle based on the curvature rate and the longitudinal jerk.

As used herein, the terms processing device, processing unit and module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

In summary, the device according to the disclosure includes at least one vehicle state sensor, at least one environment sensor and a processing unit which are configured to perform the steps as described above for the corresponding method. Therefore, the benefits, the advantages and the disclosure as described above for the method are also valid for the device according to the disclosure.

In another aspect, the present disclosure is directed at a computer system, said computer system being configured to carry out several or all steps of the computer implemented method described herein.

The computer system may comprise a processing unit, at least one memory unit and at least one non-transitory data storage. The non-transitory data storage and/or the memory unit may comprise a computer program for instructing the computer to perform several or all steps or aspects of the computer implemented method described herein.

In another aspect, the present disclosure is directed at a non-transitory computer readable medium comprising instructions for carrying out several or all steps or aspects of the computer implemented method described herein. The computer readable medium may be configured as: an optical medium, such as a compact disc (CD) or a digital versatile disk (DVD); a magnetic medium, such as a hard disk drive (HDD); a solid state drive (SSD); a read only memory (ROM); a flash memory; or the like. Furthermore, the computer readable medium may be configured as a data storage that is accessible via a data connection, such as an internet connection. The computer readable medium may, for example, be an online data repository or a cloud storage.

The present disclosure is also directed at a computer program for instructing a computer to perform several or all steps or aspects of the computer implemented method described herein.

### BRIEF DESCRIPTION OF THE DRAWINGS

Exemplary embodiments and functions of the present disclosure are described herein in conjunction with the following drawings, showing schematically:

FIG. 1 depicts an overview of a device according to the disclosure,

FIG. 2 depicts a flow diagram of a method according to the disclosure,

FIG. 3 depicts the generation of a curvature reference, and

FIGS. 4A-4C depict the effect of smoothing cost functions on the longitudinal part of estimating a scheduled trajectory.

### DETAILED DESCRIPTION

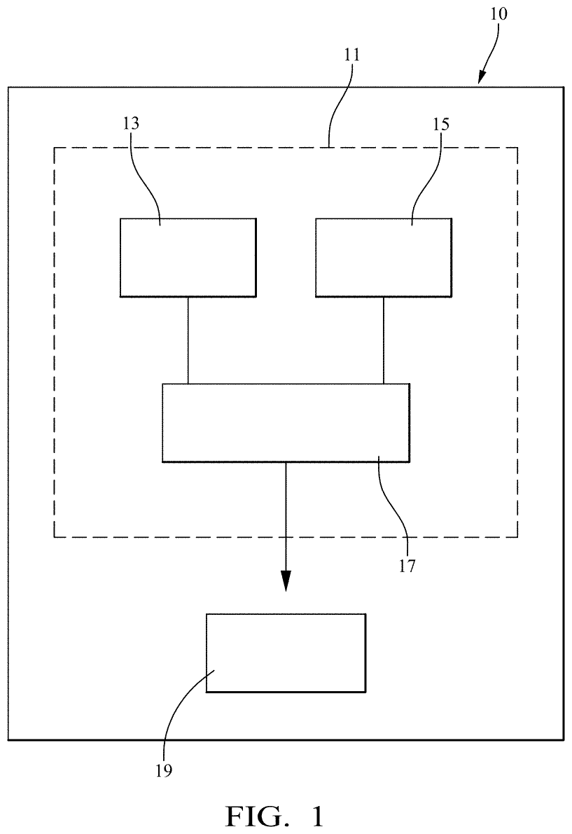

FIG. 1 depicts a schematic overview of a vehicle 10 including a device 11 for scheduling a trajectory of the vehicle 10. The device 11 includes at least one vehicle state sensor 13, at least one environment sensor 15 and a processing unit 17. The vehicle state sensor 13 and the environment sensor 15 are configured to provide data for the processing unit 17. The vehicle state sensor 13 includes a speedometer, an accelerometer and/or a device for determining the current position of the vehicle 10, e.g. a GPS-system. Hence, the vehicle state sensor 13 detects kinematic parameters of the vehicle 10. The environment sensor 15 includes a camera for monitoring the environment of the vehicle 10 and for detecting environmental parameters of the vehicle 10. Additionally or alternatively, the at least one environment sensor 15 may include a radar system and/or a Lidar system.

The processing unit 17 is configured to estimate the scheduled trajectory of the vehicle 10 based on the data provided by the vehicle state sensor 13 and environment sensor 15, as will be described in detail below. The scheduled trajectory is denoted by 19 in FIG. 1 and is the final output of the processing unit 17 and therefore of the entire device 11.

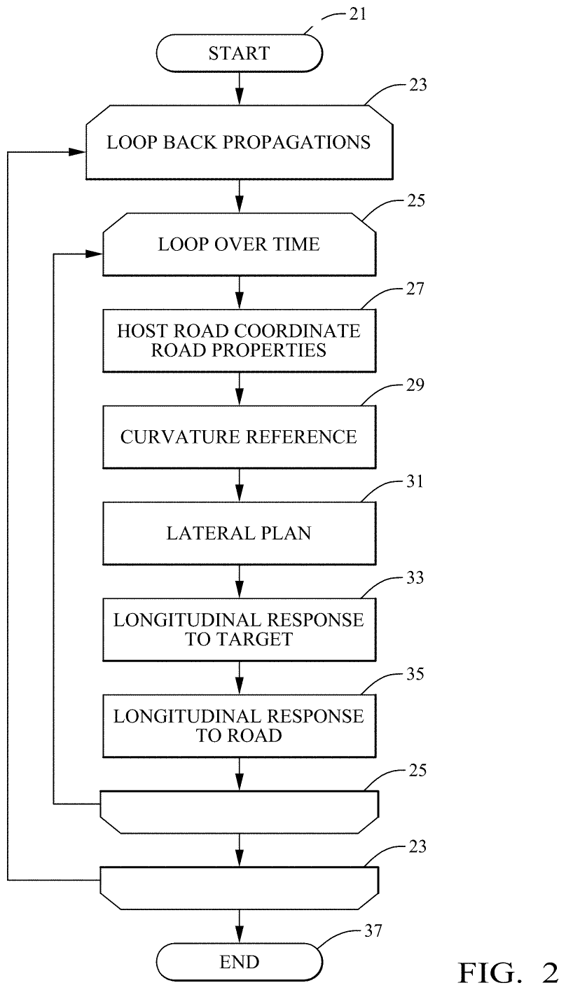

FIG. 2 schematically depicts a flow diagram of a method for scheduling the trajectory 19 of the vehicle 10. The method as shown in FIG. 2 is performed via the processing unit 17 (see FIG. 1). The method starts at 21 and enters a first loop 23 of back propagation which will be explained in detail below, and an inner loop 25 over the time. The scheduled trajectory 19 which is output by the processing unit 17 (see FIG. 1) is provided as depending on a planning index which corresponds to the elapsed time of the scheduled trajectory. In other words, each planning index refers to a time increment for the trajectory planning. Therefore, the loop 25 over time is executed once for each planning index or time increment until the entire scheduled trajectory 19 is estimated.

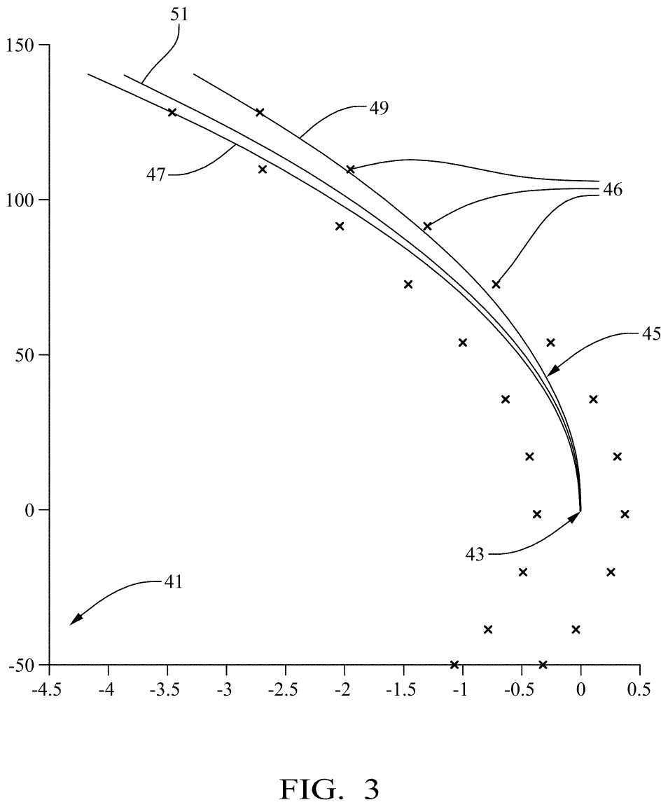

Within the loop 25 over time, a position of the vehicle 10 (which is also denoted as host vehicle) is determined in road coordinates. The road coordinates are provided as Frenet coordinates, an example of which is shown in FIG. 3. A road or Frenet coordinate system 41 includes an origin which represents the current position 43 of the vehicle or host vehicle 10. Furthermore, a lane 45 is depicted on which the vehicle 10 is currently driving and which includes lane markers 46.

In detail, the lane 45 is represented by sampled segments each of which includes information about the position and the heading of the vehicle and about curvature and width of the lane 45. That is, kinematic parameters and environmental parameters of the vehicle are determined at 27 using the vehicle state sensor 13 and the environment sensor 15 (see FIG. 1).

At 29, a curvature reference is generated for which an example is shown in FIG. 3. A minimum curvature 47 and a maximum curvature 49 are calculated such that the vehicle 10 is able to proceed at a constant curvature of the corresponding trajectory without leaving the lane 45. As can be seen in FIG. 3, the minimum curvature 47 and the maximum curvature 49 reach the lane markers 46 in a region at the end of the trajectory 19 which is to be scheduled.

A final or reference curvature 51 is determined in the region between the minimum curvature 47 and the maximum curvature 49, wherein the final curvature 51 is biased towards the minimum curvature 47 in left curves and towards the maximum curvature 49 in right curves.

Generally, the scheduled trajectory 19 is restricted to a certain horizon or range which is defined by the instrumental range of the environment sensor 15. When generating the reference curvature 51, it may not be possible to pass all the sampled lane markers 46 with a constant curvature. In this case, the most limiting lane marker 46 will be used for generating the reference curvature 51.

At 31, the lateral part of the trajectory planning is estimated, whereas at 33 and 35 the longitudinal part of the trajectory planning is estimated. The longitudinal part is split into a longitudinal response to a target object which is determined as 33 and a longitudinal response to the road which is determined at 35.

In detail, costs for lateral dynamics are determined based on a subset of the kinematic parameters and the environmental parameters which includes a lateral offset, a lateral velocity, a curvature, a yaw rate, a lateral acceleration and a lateral jerk. Similarly, costs for longitudinal dynamics are determined based on a further subset of the kinematic parameters and the environmental parameters which includes a range to an object, a speed, a constant velocity time to collision, a longitudinal acceleration and a longitudinal jerk.

These costs are therefore defined based on the parameters mentioned above and are further transformed into so-called state costs. These state costs include a lateral offset cost function, a heading cost function (wherein the heading is defined relative to the road), a curvature cost function and a curvature rate cost function for the lateral part of the trajectory planning, and the state costs include a range cost function, a range rate cost function, an acceleration cost function and a jerk cost function for the longitudinal part of the trajectory planning.

It turned out that the curvature rate and the jerk as well as their corresponding cost functions are the most suitable control values or entities for controlling the vehicle 10 and therefore for scheduling the trajectory 19.

In order to determine these control values, an equilibrium contribution or equilibrium cost for the lateral dynamics can be formulated as:

C_{o,i}+C_{h,i}+C_{c,i}+C_{k,i}=0 (1)

wherein C_{o,i} is the lateral offset cost function, C_{h,i} is the heading cost function, C_{c,i} is the curvature cost function, and C_{k,i} is the curvature rate cost function, and wherein all cost functions depend on the planning index i which indicates the number of the respective time increment. Hence, the planning index i corresponds to the elapsed time “along” the trajectory to be scheduled. Since the curvature rate is used as control value, it can be reformulated as:

C_{k,eq,i}=−(C_{o,i}+C_{h,i}+C_{c,i}) (2)

which is denoted as the equilibrium cost. This is the formulation that ensures an adequate response to an error in the kinematic states of the vehicle. This does, however, not ensure stability, so a second term or “stabilizing contribution” is defined for the final curvature rate as follows:

$${K}_{stab , i} = \frac{{C}_{k , eq , i} - ( \frac{d}{d t} {C}_{o , i} + \frac{d}{d t} {C}_{h , i} )}{{dC}_{c , i} {/}_{d {C}_{i}}} \qquad ( 3 )$$

wherein dC_{c,i}/dCᵢ is a change of curvature cost per curvature. This formulation aims to decrease C_{k,eq,i} with −C_{k,eq,i} per second. The final curvature rate being used as control value is the sum of the two contributions based on the formulas (2) and (3) as described above:

K_{tot,i}=K_{stab,i}+K_{eq,i}, wherein K_{eq,i}=fₖ(C_{k,eq,i}) (4)

and wherein fₖ is a gain function for curvature rate.

In a similar manner the equilibrium cost for longitudinal jerk is defined as

C_{j,eq,i}=−(C_{r,i}+C_{rr,i}+C_{a,i}) (5)

wherein C_{j,i} is the jerk cost function, C_{r,i} is the range cost function, C_{rr,i} is the range rate cost function and C_{a,i} is the acceleration cost function. Corresponding to formula (3), a term for ensuring stability is defined for longitudinal control as follows:

$${j}_{stab , i} = \frac{{C}_{j , eq , i} - ( \frac{d}{d t} {C}_{r , i} + \frac{d}{d t} {C}_{rr , i} )}{{dC}_{a , i} {/}_{d {A}_{i}}} \qquad ( 6 )$$

The final longitudinal jerk is therefore defined as:

j_{tot,i}=j_{stab,i}+j_{eq,i} wherein j_{eq,i}=fⱼ(C_{j,eq,i}) (7)

and wherein fⱼ is a gain function for longitudinal jerk.

The only difference between the longitudinal response to a target object and the longitudinal response to the road (see also steps 33 and 35 in FIG. 2) is that the latter does not consider a range state, and the range rate is either defined by a speed limit related to the road or the speed that is limiting the lateral acceleration (whichever is lower). The scheduled trajectory 19 will be based on the lower value of the longitudinal response to a target object and the longitudinal response to the road for each planning index, i.e. the minimum of the two response values will be used as the final longitudinal jerk.

Once the trajectory 19 has been scheduled for all planning indices within the loop 25 over time using the cost functions as defined above, smoothing is applied to the equilibrium cost functions according to the following formulation, i.e. laterally:

C_{k,eq,i}=α·0.5·C_{k,eq,i-1}+(1−α)C_{k,eq,i}+α·0.5·C_{k,eq,i+1} (8)

and similarly longitudinally:

C_{j,eq,i}=α·0.5·C_{j,eq,i-1}+(1−α)C_{j,eq,i}+α·0.5·C_{j,eq,i+1} (9)

wherein α is a smoothing constant.

The equilibrium cost functions are smoothed starting from the last planning index up to the first planning index, and thereafter the scheduled trajectory 19 is estimated again as a revised scheduled trajectory 19 starting from the first planning index up to the last planning index, i.e. by repeating the loops 25 over time (see FIG. 2) for all planning indices. Therefore, the smoothing of the cost functions in “backward” direction starting from the last planning index represents the loop 23 for back propagation which is shown in FIG. 2. In addition, the stability contributions are also calculated again according to formula (3) and formula (6) for the curvatures rate and for the longitudinal jerk, respectively, after the smoothing of the equilibrium cost functions is performed in the loop 23 for the back propagation.

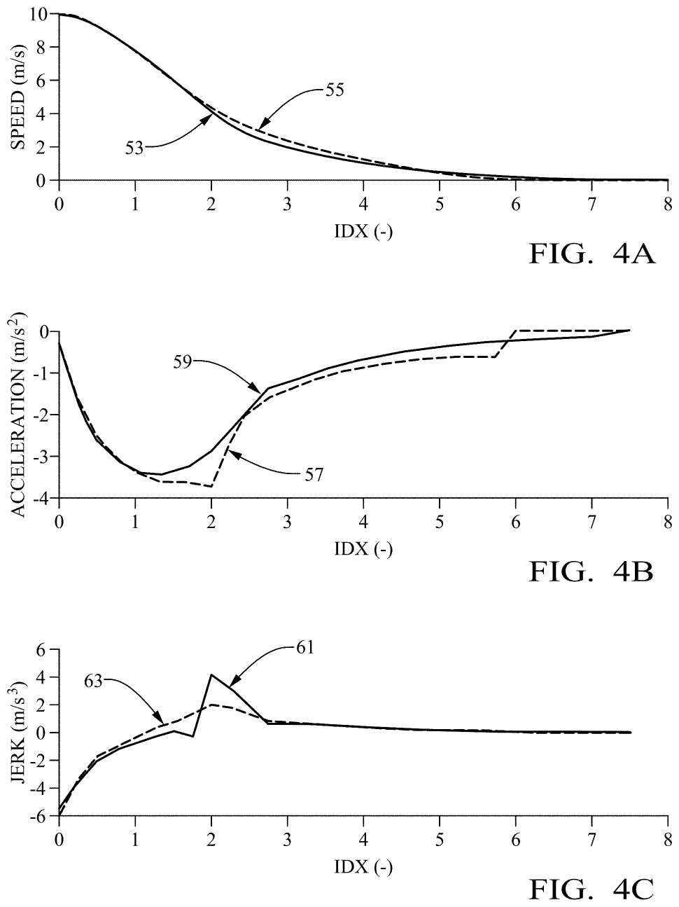

FIGS. 4A-4C depict the effect of smoothing the equilibrium cost functions on the longitudinal dynamics of the vehicle 10. In detail, the speed in m/s, the acceleration in m/s² and the jerk in m/s³ are represented by the y-axis and depicted over the planning index (corresponding to time increments) which is represented by the x-axis. The speed (FIG. 4A), the acceleration (FIG. 4B) and the jerk (FIG. 4C) of the vehicle 10 are represented by different curves for a scenario in which the vehicle 10 stops behind a moderately breaking other vehicle. As is known from elementary kinematics, the acceleration is the derivative of the speed with respect to time and the jerk is the first derivative of the acceleration and the second derivative of the speed with respect to time.

The speed, the acceleration and the jerk of the vehicle 10 before smoothing the equilibrium cost functions are represented by the curves 53, 57 and 61. In addition, the curves 55, 59 and 63 represent the speed, the acceleration and the jerk of the host vehicle 10 after smoothing the equilibrium cost functions according to formula (8) and formula (9), respectively. As can be seen, the longitudinal jerk which is used as control value shows some abrupt discontinuities in the curve 61 which are removed due to the smoothing of the cost functions in curve 63.

Therefore, the course of the scheduled trajectory 19 which is output at the end 37 (see FIG. 2) of the method will be smoothed as well. This will lead to a smoother driving behavior of the vehicle 10 when it follows the scheduled trajectory 19. Since the device 11 and the method as shown in FIGS. 1 and 2, respectively, are based on the framework of cost functions as explained above, a moderate computational effort is required for scheduling the trajectory 19 which is much lower than the computational effort required e.g. for a model predictive control.

What is claimed is:

1. A method comprising:
receiving kinematic parameters of a vehicle detected by at least one vehicle state sensor;
receiving environmental parameters of the vehicle detected by at least one environment sensor;
estimating, via a processing unit, a curvature rate and a longitudinal jerk based on respective cost functions depending from the kinematic parameters and the environmental parameters of the vehicle; and
estimating, via the processing unit, a scheduled trajectory of the vehicle based on the curvature rate and the longitudinal jerk.

2. The method according to claim 1, further comprising:
smoothing the respective cost functions after estimating the scheduled trajectory;
estimating a revised curvature rate and a revised longitudinal jerk based on the smoothed cost functions; and
estimating a revised scheduled trajectory of the vehicle based on the revised curvature rate and the revised longitudinal jerk.

3. The method according to claim 1, wherein the estimated curvature rate and the estimated longitudinal jerk each comprise an equilibrium contribution and a stabilizing contribution that depend on the respective cost functions.

4. The method according to claim 3, wherein the equilibrium contribution of the estimated curvature rate depends on a curvature rate cost function which is balanced with a lateral offset cost function, a heading cost function, and a curvature cost function.

5. The method according to claim 4, wherein the stabilizing contribution of the estimated curvature rate is defined based on the curvature rate cost function, a temporal change of the lateral offset cost function and of the heading cost function, and a change of the curvature cost function per curvature.

6. The method according to claim 4,
wherein the cost related to lateral dynamics of the vehicle is estimated based on a subset of the kinematic parameters and of the environmental parameters of the vehicle, and
wherein the cost related to lateral dynamics is transformed in order to determine the curvature rate cost function, the lateral offset cost function, the heading cost function, and the curvature cost function.

7. The method according to claim 3, wherein the equilibrium contribution of the estimated longitudinal jerk depends on a longitudinal jerk cost function which is balanced with a range cost function, a range rate cost function, and an acceleration cost function.

8. The method according to claim 7, wherein the stabilizing contribution of the estimated longitudinal jerk is defined based on the longitudinal jerk cost function, a temporal change of the range cost function and of the range rate cost function, and a change of the acceleration cost function per acceleration.

9. The method according to claim 7,
wherein cost related to longitudinal dynamics of the vehicle is estimated based on a subset of the kinematic parameters and of the environmental parameters of the vehicle, and
wherein the cost related to longitudinal dynamics is transformed in order to determine the longitudinal jerk cost function, the range cost function, the range rate cost function, and the acceleration cost function.

10. The method according to claim 1,
wherein the estimated longitudinal jerk includes a longitudinal response to a target object and a longitudinal response to a course of a lane on which the vehicle is currently located, and
wherein the longitudinal response to the target object depends on a range to the target object.

11. The method according to claim 10, wherein the minimum of the longitudinal response to the target object and the longitudinal response to the course of the lane is selected as the estimated longitudinal jerk.

12. The method according to claim 1, wherein estimating the scheduled trajectory of the vehicle is further based on a reference curvature which is determined based a course of a lane derived from the environmental parameters.

13. A system comprising:
at least one vehicle state sensor configured to detect kinematic parameters of a vehicle;
at least one environment sensor configured to detect environmental parameters of the vehicle; and
a processing unit configured to:
estimate a curvature rate and a longitudinal jerk based on respective cost functions depending from the kinematic parameters and the environmental parameters of the vehicle, and
estimate a scheduled trajectory of the vehicle based on the curvature rate and the longitudinal jerk.

14. The system according to claim 13, wherein the processing unit is further configured to:
smooth the respective cost functions after estimating the scheduled trajectory;
estimate a revised curvature rate and a revised longitudinal jerk based on the smoothed cost functions; and
estimate a revised scheduled trajectory based on the revised curvature rate and the revised longitudinal jerk.

15. The system according to claim 13, wherein the estimated curvature rate and the estimated longitudinal jerk each comprise an equilibrium contribution and a stabilizing contribution that depend on the respective cost functions.

16. The system according to claim 15, wherein the equilibrium contribution of the estimated curvature rate depends on a curvature rate cost function that is balanced with a lateral offset cost function, a heading cost function, and a curvature cost function.

17. The system according to claim 16, wherein the stabilizing contribution of the estimated curvature rate is defined based on the curvature rate cost function, a temporal change of the lateral offset cost function and of the heading cost function, and a change of the curvature cost function per curvature.

18. The system according to claim 15, wherein the equilibrium contribution of the estimated longitudinal jerk depends on a longitudinal jerk cost function that is balanced with a range cost function, a range rate cost function, and an acceleration cost function.

19. The system according to claim 13,
wherein the estimated longitudinal jerk includes a longitudinal response to a target object and a longitudinal response to a course of a lane on which the vehicle is currently located, and
wherein the longitudinal response to the target object depends on a range to the target object.

20. The system according to claim 13, wherein estimating the scheduled trajectory of the vehicle is further based on a reference curvature that is determined based a course of a lane derived from the environmental parameters.
